(19) United States
(12) Patent Application Publication
(10) Pub. No.: US 2021/0296797 A1
(43) Pub. Date: Sep. 23, 2021

(54) TERMINAL CAP

(71) Applicant: YAZAKI CORPORATION, Tokyo (JP)

(72) Inventor: Takayuki Kato, Makinohara-shi (JP)

(21) Appl. No.: 17/204,843

(22) Filed: Mar. 17, 2021

(30) Foreign Application Priority Data
Mar. 18, 2020 (JP) 2020-048293

(51) Int. Cl. H01R 4/30; H01R 11/28; H01R 13/453

(52) U.S. Cl. CPC H01R 4/305; H01R 13/453; H01R 11/283

(57) ABSTRACT

A terminal cap for covering a terminal that is attached to an end portion of an electric wire and is connected to a counterpart device, includes a first cover having a polygonal tubular shape and configured to cover a portion where the terminal is attached to the electric wire, and a second cover that is continuous with the first cover and configured to cover a portion where the terminal is connected to the counterpart device.

### CROSS REFERENCE TO RELATED APPLICATIONS

This application is a based on Japanese Patent Application No. 2020-048293 filed on Mar. 18, 2020, the contents of which are incorporated herein by reference.

### BACKGROUND OF THE INVENTION

### 1. Field of the Invention

The present disclosure relates to a terminal cap.

### 2. Description of the Related Art

A terminal cap used for a terminal connected to a battery, an alternator, or the like mounted on a vehicle has been proposed in the past.

For example, one of terminal caps according to the related art includes a dome-shaped part covering a portion where a terminal is bolted to an electrode portion of a battery or the like, and a cylindrical part extending along the terminal and an electric wire. When the terminal cap is attached to the terminal, an electric wire is drawn out from an opening end (so-called opening or frontage) of a cylindrical part of the terminal cap (see, for example, JP-B-4973942).

When the terminal cap according to the related art described above is actually used, the cylindrical part (particularly, the opening) of the terminal cap may come into contact with the terminal or the electric wire when a bolted portion of the terminal is covered with the dome-shaped part of the terminal cap, which is caused by dimensional tolerances (so-called manufacturing variations) of the terminal, unintended deformation (so-called bend-up and bend-down) of the terminal that may occur during operation, or the like. In this case, for example, a positional displacement or the like of the dome-shaped part of the terminal cap may occur. Such positional displacement of the terminal cap is desirably suppressed as much as possible because an original function (water stopping property and the like) of the terminal cap may be impaired.

An object of the present disclosure is to provide a terminal cap whose positional displacement during use can be suppressed.

### SUMMARY OF THE INVENTION

In order to achieve the above object, the present disclosure provides a terminal cap for covering a terminal that is attached to an end portion of an electric wire and is connected to a counterpart device, the terminal cap including:

a first cover having a polygonal tubular shape and configured to cover a portion where the terminal is attached to the electric wire; and

a second cover that is continuous with the first cover and configured to cover a portion where the terminal is connected to the counterpart device.

As described above, according to the present disclosure, it is possible to provide a terminal cap whose positional displacement during the use of a terminal can be prevented.

The present disclosure has been briefly described above. Further, details of the present disclosure will be further clarified by reading through embodiments for carrying out the present disclosure described below with reference to the accompanying drawings.

### BRIEF DESCRIPTION OF THE DRAWINGS

FIG. 1 is a perspective view of a terminal cap according to an embodiment of the present disclosure.

FIG. 2 is a side view of the terminal cap shown in FIG. 1.

FIG. 3 is a front view of an opening end of a tubular portion of the terminal cap shown in FIG. 1 (illustration of an electric wire is omitted).

FIG. 4 is a cross-sectional view taken along a line A-A in FIGS. 1 and 3.

FIG. 5 is a view corresponding to FIG. 4 according to a modification.

FIG. 6 is a view corresponding to FIG. 3 according to another modification.

### DETAILED DESCRIPTION OF THE EXEMPLARY EMBODIMENTS

### Embodiment

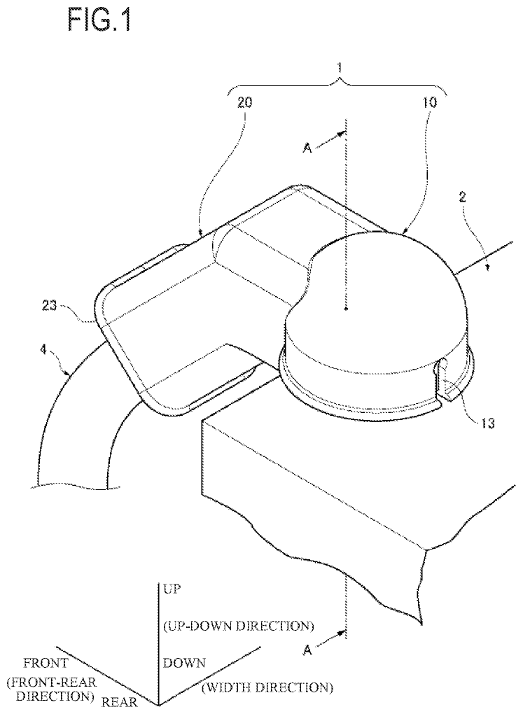

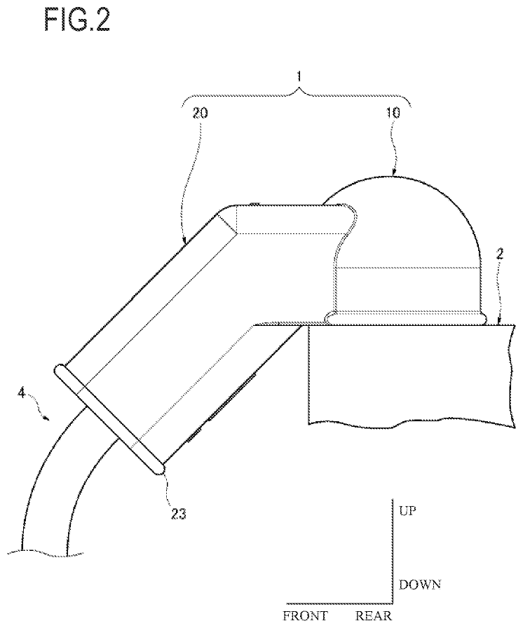

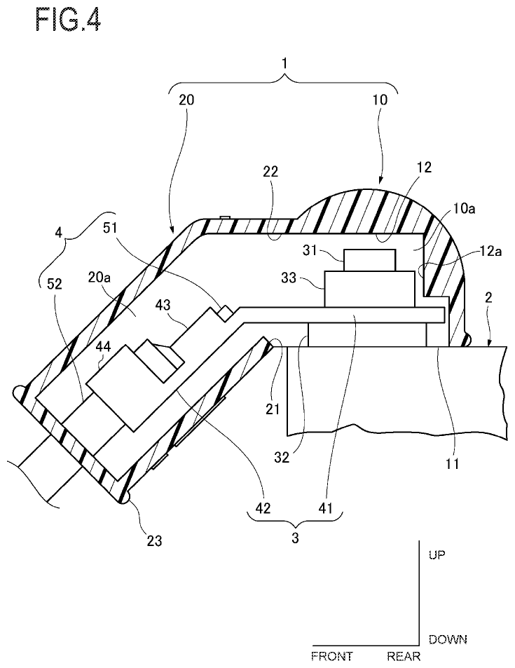

Hereinafter, a terminal cap 1 according to an embodiment of the present disclosure will be described with reference to the drawings. As shown in FIGS. 1 to 4, the terminal cap 1 is a cap that is connected to an end portion of an electric wire 4 and covers a terminal 3 fixed to a counterpart device 2 (see FIG. 4), and has a function of protecting the terminal 3. Hereinafter, for convenience of description, a “front-rear direction”, a “width direction”, an “up-down direction”, “front”, “rear”, “up”, and “down” are defined as illustrated in FIG. 1. The “front-rear direction”, the “width direction”, and the “up-down direction” are orthogonal to each other.

A battery, an alternator, or the like mounted on a vehicle are assumed as the counterpart device 2. In this example, as shown in FIG. 4, a bolt-shaped metal electrode portion 31 protruding upward and a resin-formed bush 32 supporting an outer periphery of a root portion of the electrode portion 31 are provided at a corner portion of an upper face of the counterpart device 2. The counterpart device 2 and the terminal 3 are electrically connected to each other by fixing an electrode connecting portion 41 (described later) of the terminal 3 to the electrode portion 31.

The terminal 3 is made of metal, and in this example, the terminal 3 integrally includes the electrode connecting portion 41 to be fixed to the electrode portion 31 of the counterpart device 2 and an electric wire connecting portion 42 to be connected to the end portion of the electric wire 4. The electrode connecting portion 41 has a flat plate shape extending in the front-rear direction, and a through hole (not shown) penetrating in the up-down direction, into which the electrode portion 31 is inserted, is formed in a rear end portion of the electrode connecting portion 41.

The electric wire connecting portion 42 has a shape extending obliquely forward and downward from a front end portion of the electrode connecting portion 41 A pair of core wire crimping pieces 43 for crimping and fixing a core wire 51 of the electric wire 4 are provided on a root side (a side close to the electrode connecting portion 41) of the electric wire connecting portion 42, and a pair of covering crimping pieces 44 for crimping and fixing a covering 52 that covers the core wire 51 of the electric wire 4 are provided on a distal end side (a side far from the electrode connecting portion 41) of the electric wire connecting portion 42. The core wire 51, which is exposed after the covering 52 is removed, at an end portion of the electric wire 4 is crimped and fixed by the pair of core wire crimping pieces 43, and the covering 52 at the other end portion of the electric wire 4 is crimped and fixed by the pair of covering crimping pieces 44, and thereby, the electric wire 4 is fixed to the terminal 3 and is electrically connected to the terminal 3.

The configuration of the terminal cap 1 will be described below. The terminal cap 1 is made of elastic rubber, and integrally includes, as shown in FIGS. 1 to 4, a base portion 10 that covers a portion (specifically, the periphery of the electrode portion 31 and the electrode connecting portion 41 of the terminal 3) where the terminal 3 and the counterpart device 2 are fixed to each other, and a tubular portion 20 that extends from the base portion 10 and covers a portion (specifically, the periphery of the electric wire connecting portion 42 of the terminal 3) where the terminal 3 and the electric wire 4 are connected with each other.

The base portion 10 has a substantially hemispherical outer shape, and a substantially circular opening 11 is formed on a lower face of the base portion 10. An internal space 10a continuous with the opening 11 and recessed upward is formed inside the base portion 10. The electrode portion 31, the electrode connecting portion 41 of the terminal 3, and the like are accommodated in the internal space 10a. As shown in FIG. 1, a notch portion 13 extending upward from a peripheral edge portion of the opening 11 is formed on a rear side portion of the base portion 10. The notch portion 13 is used to temporarily widen the opening 11 of the base portion 10 in order to improve workability when work of attaching the terminal cap 1 to the terminal 3 is performed. The structure of the internal space 10a will be described in more detail later.

The tubular portion 20 has a rectangular tubular shape, and extends obliquely forward and downward from a front side portion of the base portion 10 so as to correspond to an extending direction of the electric wire connecting portion 42 of the terminal 3. An internal space 20a of the tubular portion 20 communicates with the internal space 10a of the base portion 10, and a shape of a cross section of the internal space 20a is a square shape. The electric wire connecting portion 42 of the terminal 3 and the electric wire 4 extending from the electric wire connecting portion 42 are accommodated in the internal space 20a.

An end edge 21 (see FIG. 4) of a lower side wall of a root portion (a part connected to the base portion 10) of the tubular portion 20 has an arc shape when viewed from above, and constitutes a part of the peripheral edge portion of the opening 11 of the base portion 10. In this example, an inner wall surface 22 of an upper side wall of the root portion of the tubular portion 20 is continuous with an inner wall surface 12 of an upper side wall of the base portion 10 without any step (see FIG. 4). In a state in which the terminal cap 1 is attached to the terminal 3, the inner wall surface 12 (particularly, a side wall part 12a around a nut 33) covers the nut 33 in a circumferential direction. Accordingly, even when an external force in a width direction or a front direction is applied to the terminal cap 1, the nut 33 and the side wall portion 12a of the inner wall surface 12 come into contact with each other, and the base portion 10 and the like are prevented from being displaced upward by a frictional force generated between the nut 33 and the side wall part 12a.

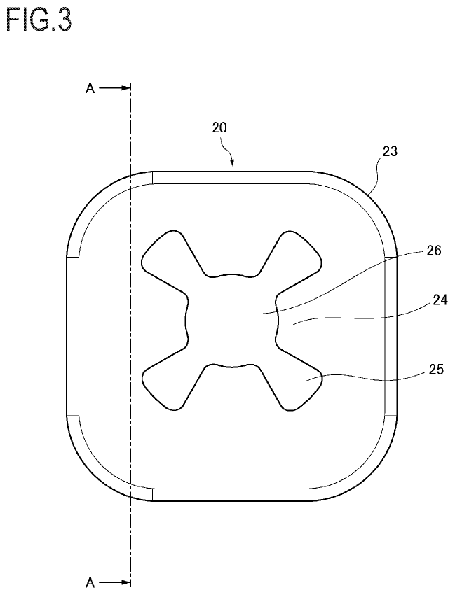

As shown in FIG. 3, a square-shaped opening end 23 of an extended end portion of the tubular portion 20 is provided with a plurality of (four in this example) extended pieces 24 extending inward from a peripheral edge portion of the opening end 23. An insertion passage 26 through which the electric wire 4 is inserted is defined by extended ends of the plurality of extended pieces 24. A slit-shaped gap 25 is formed between the adjacent extended pieces 24. The gap 25 extends inward (that is, toward the insertion passage 26) from a corner portion of the square-shaped opening end 23.

Since the gap 25 is formed between the adjacent extended pieces 24 as described above, rigidity of the extended pieces 24 is reduced, and the extended pieces 24 can be easily curved. Further, the formation of the gap 25 facilitates the work of removing the terminal cap 1 after molding when the terminal cap 1 is molded using the mold. The configuration of the terminal cap 1 has been described above.

Next, work of attaching the terminal cap 1 to the terminal 3 will be described. First, the terminal 3 is attached to the end portion of the electric wire 4. Specifically, the core wire 51 exposed from the end portion of the electric wire 4 is crimped and fixed by the pair of core wire crimping pieces 43 of the terminal 3, and the covering 52 of the end portion of the electric wire 4 is crimped and fixed by the pair of covering crimping pieces 44. Accordingly, the electric wire 4 is fixed to the terminal 3 and electrically connected to the terminal 3. Next, the end portion of the electric wire 4 is inserted from the opening end 23 (insertion passage 26) of the tubular portion 20 of the terminal cap 1, and the end portion of the electric wire 4 is led out to the outside of the terminal cap 1 through the inner space 20a of the tubular portion 20, the internal space 10a of the base portion 10, and the opening 11 of the base portion 10. Further, the electric wire 4 and the tubular portion 20 are temporarily fixed to each other using an adhesive tape or the like.

Next, the base portion 10 of the terminal cap 1 is turned over so as to be turned upside down, and the electrode connecting portion 41 of the terminal 3 is exposed from the terminal cap 1. Then, the electrode portion 31 of the counterpart device 2 is inserted into the through hole of the electrode connecting portion 41 of the terminal 3 from below, and the electrode connecting portion 41 is placed on an upper face of the bush 32. Next, in a state in which the orientation of the terminal 3 is maintained such that the electric wire connecting portion 42 extends forward, the electrode connecting portion 41 is fastened and fixed to the electrode portion 31 using the nut 33 made of metal such that the electrode connecting portion 41 is interposed between the nut 33 and the bush 32.

Next, the electrode connecting portion 41 and the periphery thereof are covered by the base portion 10 while the base portion 10 of the terminal cap 1, which is turned upside down, is returned to the original state. Thus, as shown in FIG. 4, the portion where the terminal 3 and the counterpart device 2 are fixed to each other is covered by the base portion 10, and the portion where the terminal 3 and the electric wire 4 are connected to each other and the electric wire 4 located in a vicinity of the portion are covered by the tubular portion 20. Thus, the work of attaching the terminal cap 1 to the terminal 3 is completed.

As another method of attaching the terminal cap 1 to the terminal 3, for example, the terminal 3 may be attached to the electric wire 4 in a state in which the electric wire 4 is inserted into the base portion 10 and the tubular portion 20 of the terminal cap 1. Further, instead of turning over the base portion 10 as described above, the electrode connecting portion 41 of the terminal 3 and the electrode portion 31 of the counterpart device 2 may he fastened and fixed after the terminal cap 1 is moved so as to slide along the electric wire 4 in a direction away from the terminal 3.

In a state in which the terminal cap 1 is attached to the terminal 3, the electric wire 4 connected to the terminal 3 is led out to the outside of the terminal cap 1 through the opening end 23 of the tubular portion 20, and is supported by the plurality of extended pieces 24 in the insertion passage 26 of the opening end 23. However, since the extended pieces 24 can be easily curved, the electric wire 4 inserted into the insertion passage 26 can freely move in an inner region of the peripheral edge portion of the opening end 23 with curving of the extended pieces 24.

### <Operation and Effect>

As described above, according to the terminal cap 1 of the present embodiment, the tubular portion 20 has a rectangular tubular shape so as to conform to a shape of an allowable space having a polygonal tubular shape (in particular, a rectangular tubular shape) in general. Therefore, the allowable space can be effectively used, and a large area of the opening of the tubular portion 20 can be ensured. Accordingly, for example, even if dimensional tolerances of the terminal 3, unintended deformation of the terminal 3 that may occur during work, or the like occurs, the electric wire 4 is less likely to come into contact with the peripheral edge portion of the opening end 23 of the tubular portion 20, and the displacement of the terminal cap 1 can be prevented.

According to the terminal cap 1 of the present embodiment, the extended pieces 24 are provided at the opening end 23 of the tubular portion 20, and thereby, foreign matter is less likely to enter the inside of the terminal cap 1 (particularly, a portion where the counterpart device 2 is connected with the terminal 3 and a portion where the electric wire 4 is connected with the terminal 3). Although the opening area of the opening end 23 is reduced by the extended pieces 24, the rigidity of the extended pieces 24 is generally small and the extended pieces 24 can be easily curved. Therefore, the effect of preventing the positional displacement of the terminal 3 is not particularly impaired.

### Other Embodiments

The present disclosure is not limited to the above-described embodiment and various modifications can be used within the scope of the present disclosure. For example, the present disclosure is not limited to the above-described embodiment, and may be appropriately modified, improved or the like. In addition, the material, shape, size, number, arrangement position, and the like of each component in the above embodiment can be set as desired and are not limited as long as the present disclosure can be achieved.

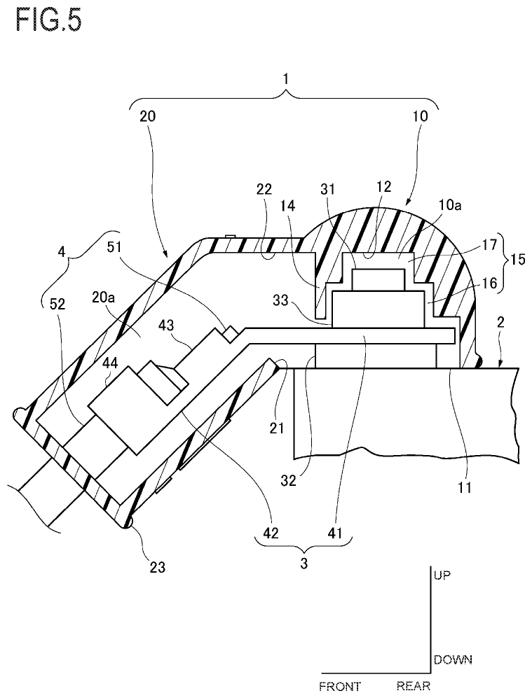

In the above embodiment, the inner wall surface 22 of the upper side wall of the root portion of the tubular portion 20 is continuous with the inner wall surface 12 of the upper side wall of the base portion 10 without any step (see FIG. 4). On the other hand, as shown in FIG. 5, a hanging portion 14 protruding downward may be provided on the inner wall surface 12 located in a vicinity of a boundary between the inner wall surface 22 and the inner wall surface 12. By providing the hanging portion 14, in a state in which the terminal cap 1 is attached to the terminal 3, a recessed portion 15, which includes a recessed portion 16 that covers the nut 33 over a circumferential direction and a second recessed portion 17 that covers the electrode portion 31 protruding upward from the nut 33 over the circumferential direction, is defined in the internal space 10a of the base portion 10. Therefore, as compared with a mode in which the hanging portion 14 is not provided, the terminal cap 1 is less likely to he detached from the terminal 3 when an unintended external force acts on the terminal cap 1.

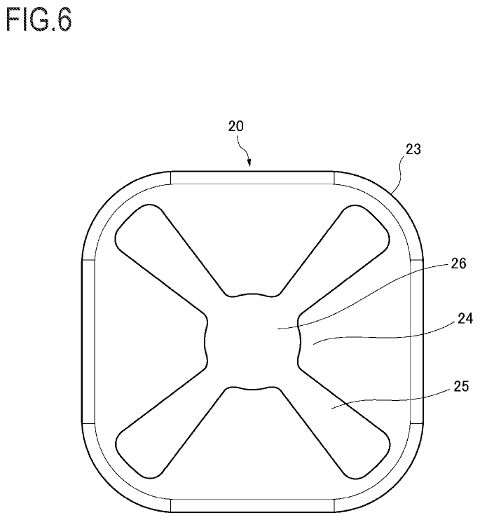

In the above embodiment, the gap 25 provided between the plurality of extended pieces 24 provided at the opening end 23 of the tubular portion 20 extends from the insertion passage 26 to a substantially central position between the insertion passage 26 and an edge of the corner portion of the opening end 23 (see FIG. 3). On the other hand, as shown in FIG. 6, the gap 25 provided between the plurality of extended pieces 24 may extend from the insertion passage 26 to a vicinity of the edge of the corner portion of the opening end 23. Further, the extended pieces 24 may not be provided at the opening end 23 of the tubular portion 20.

Further, in the above embodiment, the tubular portion 20 has a rectangular tubular shape. On the other hand, the tubular portion 20 may have a polygonal tubular shape having five or more corners, such as a pentagonal tubular shape or a hexagonal tubular shape.

Here, the features of the embodiment of the terminal cap 1 according to the present disclosure described above will be briefly summarized and listed in the following [1] to [4].
[1] A terminal cap (1) for covering a terminal (3) that is attached to an end portion of an electric wire (4) and is connected to a counterpart device (2), the terminal cap (1) including:

a first cover (20) having a polygonal tubular shape and configured to cover a portion where the terminal (3) is attached to the electric wire (4); and

a second cover (10) that is continuous with the first cover (20) and configured to cover a portion where the terminal (3) is connected to the counterpart device (2).
[2] The terminal cap (1) according to the above [1],

wherein the first cover (20) has a rectangular tubular shape.
[3] The terminal cap (1) according to the above [1] or [2],

wherein the first cover (20) has at least one extended piece (24) extending inward from a peripheral edge portion of an opening end (23) of the first cover (20).
[4] The terminal cap (1) according to the above [3],

wherein the at least one extended piece (24) is a plurality of extended pieces (24), and

a slit-shaped gap (25) defined between adjacent two of the plurality of extended pieces (24) extends inward from a corner portion of the opening end (23) of the first cover (20).

The terminal cap having the configuration of [1] will be described below When the terminal cap is used for a terminal to he connected to an electrode portion of a battery or the like of a vehicle, a size and a shape of the terminal cap are generally limited so that the terminal cap does not interfere with a peripheral device. That is, the terminal cap is generally designed so as to fit in a space between peripheral devices (hereinafter, referred to as “allowable space”). Since an outer shape of the peripheral device can be regarded as a combination of planes, the allowable space is also often defined as a space separated by planes. Since the first cover of the terminal cap having the above-described configuration has a polygonal tubular shape, an allowable space having a shape separated by such a plane can be effectively used. In other words, as compared with the above-described tubular terminal cap according to the related art, the terminal or the electric wire is less likely to come into contact with the opening of the first cover when unintended deformation such as bend-up or bend-down occurs in the terminal. Therefore, the terminal cap having the present configuration can effectively utilize the limited allowable space, and can prevent the positional displacement of the terminal cap during use.

The terminal cap having the configuration of the above [2] will be described below. In general, the allowable space described above often has a rectangular tubular shape partitioned by four planes. Therefixe, when the first cover of the terminal cap has a rectangular tubular shape, the limited allowable space can be more effectively used, and the positional displacement of the terminal cap during use can be more appropriately prevented.

According to the terminal cap having the configuration of the above [3], the at least one extended piece is provided at the opening end (opening/frontage) of the first cover, so that foreign matter is less likely to enter the inside of the terminal cap. When the extended piece is provided, the opening area of the opening is reduced. However, this does not particularly affect the effect of preventing the positional displacement of the terminal cap described above. That is, since the extended piece can be easily curved in general, an external force enough to cause a positional displacement of the terminal cap does not reach the first cover or the like even if the terminal or the electric wire is temporarily brought into contact with the extended piece.

According to the terminal cap having the configuration of the above [4], the plurality of extended pieces are configured such that the slit-shaped gap extends inward from the corner portion of the opening of the first cover. This facilitates the work of attaching the terminal cap to the terminal. Further, when the terminal cap is actually manufactured, it is also easy to remove the terminal cap after molding from a mold.

What is claimed is:

1. A terminal cap for covering a terminal that is attached to an end portion of an electric wire and is connected to a counterpart device, the terminal cap comprising:
a first cover having a polygonal tubular shape and configured to cover a portion where the terminal is attached to the electric wire; and
a second cover that is continuous with the first cover and configured to cover a portion where the terminal is connected to the counterpart device.

2. The terminal cap according to claim 1,
wherein the first cover has a rectangular tubular shape.

3. The terminal cap according to claim 1,
wherein the first cover has at least one extended piece extending inward from a peripheral edge portion of an opening end of the first cover

4. The terminal cap according to claim 3,
wherein the at least one extended piece is a plurality of extended pieces; and
wherein a slit-shaped gap defined between the plurality of extended pieces extends inward from a corner portion of the opening end of the first cover.
